(19) United States
(12) Patent Application Publication
(10) Pub. No.: US 2020/0037716 A1
(43) Pub. Date: Feb. 6, 2020

(54) PROTECTIVE CASE OF OUT-FOLDING IMAGE DISPLAY DEVICE PROVIDED WITH FLEXIBLE DISPLAY DEVICE HAVING LOWER COVER TO WHICH SCREEN TRANSMISSION WINDOW IS APPLIED

(71) Applicant: GANAHANDONGJIDUL INC., Seoul (KR)

(72) Inventor: You Seob Lim, Goyang (KR)

(21) Appl. No.: 16/339,368

(22) PCT Filed: Oct. 23, 2017
(86) PCT No.: PCT/KR2017/011705

§ 371 Date: Apr. 4, 2019

(30) Foreign Application Priority Data
Oct. 25, 2016 (KR) 10-2016-0138950

(51) Int. Cl. A45C 11/00; H04B 1/3888

(52) U.S. Cl. CPC A45C 11/00; G06F 1/1626; H04B 1/3888

(57) ABSTRACT

The present invention relates to a protective case of an out-folding image display device provided with a lower cover to which a screen transmission window is applied. Even when applied to an out-folding image display device, without opening a lower cover of a diary-type case or a bumper-integrated type case that freely allows a screen display area to be folded or unfolded about a folding axis without interference, and without opening the lower cover, the protective case of the present invention enables a user to easily check image information on a lower surface of a flexible image display device that is received and activated in a folded state inside the lower cover.

### TECHNICAL FIELD

The following disclosure relates to a protective case for an out-folding image display device, and more particularly, to a protective case in which folding and unfolding of a flexible display device are not limited even when applied to an out-folding image display device in which display surfaces of the flexible display device including a flexible OLED are folded to each other about a folding axis.

### BACKGROUND ART

Due to the popularization of the shape invariant image display devices such as existing plate type smartphones and tablet devices, additional products such as a diary type case (Korean Patent No. 10-1192287 and Korean Utility Model No. 30-0473451) which can receive the image display device in the inner space of the diary type cover and can store cards, and a bumper integrated type case (Korean Utility Model No. 20-0460260) in which a diary type case function is added to the bumper case are being widely used, and various patents related thereto are being proposed.

The diary type case and the bumper integrated type case include a lower surface fixing plate which is coherently fixed or assembled to the opposite surface of a screen display surface of an existing shape invariant image display device such as a smart phone or a tablet, a rotating connection plate whose one end portion is extended from the lower surface fixing plate or is adhesively connected to one end portion of the lower surface fixing plate, and an upper surface cover plate which is extended from or adhesively connected to the opposite end portion of the rotating connection plate to selectively cover the screen display surface. Also, a basic transmission window for checking the screen information is formed on the inner surface of the upper surface cover plate to allow a user to check the screen information without opening the pockets for storing cards and the upper surface cover plate.

The diary type case and the bumper integrated type case are all proposed to be applicable to a shape invariant image display device in a plate shape, and is not applicable to an out-folding image display device in which the screen transmission window for checking information on the screen display surface is applied only to the upper surface cover plate and a flexible display device is folded and unfolded to change the circumference shape thereof.

### DISCLOSURE

### Technical Problem

Accordingly, the present disclosure provides a protective case of an out-folding image display device provided with a lower cover to which a screen transmission window is applied. Even when applied to an out-folding image display device, without opening a lower cover of a diary type case or a bumper integrated type case that freely allows a screen display area to be folded or unfolded about a folding axis without interference, and without opening the lower cover, the protective case of the present invention enables a user to easily check image information on a lower surface of a flexible image display device that is received and activated in a folded state inside the lower cover.

### Technical Solution

In one general aspect, a protective case of an out-folding image display device includes a separate screen transmission window and a camera window on the lower cover of the protective case, thereby allowing folding and unfolding of the image display area to be freely performed about a folding axis without interference even when applied to the out-folding image display device. Other features and aspects will be apparent from the following detailed description, the drawings, and the claims.

### Advantageous Effects

According to an embodiment of the present invention, image information on the lower surface of a flexible image display device received in the inner side of the lower cover can be immediately checked by a user even though the lower cover of the diary type protective case or the bumper integrated protective case applied to the out-folding image display device is not opened.

### DESCRIPTION OF DRAWINGS

FIG. 1 is a conceptual view illustrating basic transmission windows applied to a diary type case and a bumper integrated type case applied to shape invariant image display devices such as an existing plate type smartphone and a tablet device.

FIG. 2 is an exemplary view illustrating a screen transmission window applied to a lower cover of a protective case for an out-folding image display device, in which folding and unfolding of the screen display area can be freely performed about a folding axis without interference even when applied to the out-folding image display device.

### BEST MODE

Hereinafter, exemplary embodiments of the present invention will be described in detail with reference to the accompanying drawings.

The terminology used herein is for the purpose of illustrating embodiments and is not intended to limit the present invention. In this disclosure, the singular form includes plural forms unless otherwise specified. In addition, reference numerals presented in the order of description are not necessarily limited to the order.

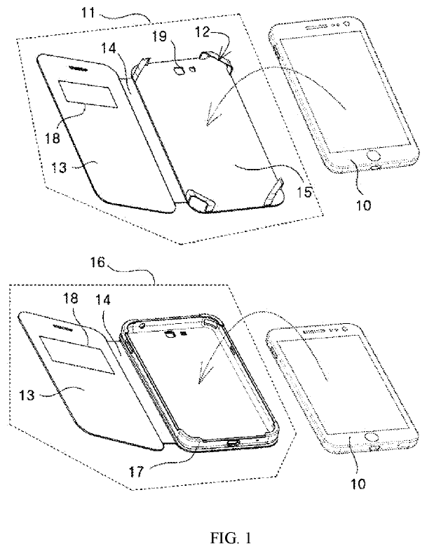

FIG. 1 is a conceptual view illustrating basic transmission windows applied to a diary type case and a bumper integrated type case applied to shape invariant image display devices such as an existing plate type smartphone and a tablet device.

As shown in FIG. 1, additional products such as a diary type case 11 (Korean Patent No. 10-1192287 and Korean Utility Model No. 30-0473451) and a bumper integrated type case 16 (Korean Registered Utility Model No. 20-0460260) are being applied to a shape invariant image display device 10 such as existing plate type smartphones and tablets in order to protect the shape invariant image display device 10 and add a storage function.

As shown in FIG. 1, the diary type case 11 includes an upper surface cover plate 13, a rotating connection plate 14, and a lower surface fixing plate 15. The upper surface cover plate 13 is rotated by a user to selectively cover the screen display surface of the shape invariant image display device 10. The rotating connection plate 14 is extended from one end portion of a rotation axis or is adhered or fixed to the end portion of the rotation axis of the upper surface cover plate 13 using a material which is easily unfolded and folded separately from the upper surface cover plate 13. Also, the lower surface fixing plate 15 is formed to extend from one end of the rotating connection plate 14, or is adhesively connected to one end of the rotation connection plate 14. The lower surface fixing plate 15 is adhesively fixed to the opposite surface of the screen display surface of the shape invariant image display device 10. The shape invariant image display device 10 is fixed to the edges by fixing bands 12 of the lower surface fixing plate 15 so as not to be rotatable.

The fixing of the shape invariant image display device 10 to the lower surface fixing plate 15 is performed by a adhesion method, a hooking method using the fixing band 12, and a screw fixing method of the lower fixing plate 15 using a fixing screw on the opposite surface of the screen display surface of the shape invariant image display device 10.

As shown in FIG. 1, the bumper integrated type case 16 includes an upper surface cover plate 13, a rotating connection plate 14, and a bumper lower plate 17. The upper surface cover plate 13 is rotated by a user to selectively cover the screen display surface of the shape invariant image display device 10. The rotating connection plate 14 is extended from one end portion of a rotation axis or is adhered or fixed to the end portion of the rotation axis of the upper surface cover plate 13 using a material which is easily unfolded and folded separately from the upper surface cover plate 13. The bumper lower plate 17 surrounds the outer circumference of the shape invariant image display device 10 without a broken portion and is fixed so as not to be rotatable. The bumper lower plate 17 is adhesively connected to the rotating connection plate 14 such that the screen display portion is opened but the opposite surface of the screen display surface is closed.

As shown in FIG. 1, the lower surface fixing plate 15 and the bumper lower plate 17 are fixed to the opposite surface of the screen display surface of the image display device such that the lower surface fixing plate 15 and the bumper lower plate 17 cannot be opened and rotated like the upper surface cover plate 13. Accordingly, when the diary type case 11 or the bumper integrated type case 16 is applied to the out-folding image display device, due to the lower surface fixing plate 15 or the bumper lower plate 17 which cannot be opened and rotated when the out-folding image display device are opened by a hinge, the folding storage display surface folded and housed inside the fixing plate 15 and the bumper lower plate 17 is restrained in a folded state, causing unfolding thereof to be impossible.

Accordingly, it can be seen that a protective case for an out-folding image display device 20 which changes in its circumference shape unlike the shape invariant image display device 10 when a flexible display device is folded and unfolded is needed. To this end, various forms of protective cases have been filed by the present applicant.

In addition, it is desirable that an out-folding image display device provided with a flexible display device has a function of recognizing a surface exposed to a user and activating the exposed surface even though any surface is exposed in a folded state due to the folding property of the screen display surface.

In the out-folding image display device having such an exposed surface recognizing function, when the activated exposure surface is a surface located on the side of the lower cover to which the basic transmission window is not applied, the display information can be checked only by opening the lower cover. In a lower cover forming the protective case of the out-folding image display device of the above-described patent filed by the present applicant, since a separate transmission window for the lower surface is not applied separately from the basic transmission window, the image information of the lower surface of the flexible image display device which is received and activated inside the lower cover in a folded state cannot be checked as long as the lower cover is not opened.

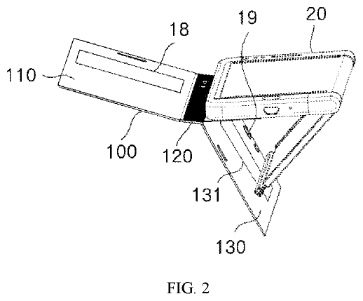

In order to overcome this limitation, FIG. 2 illustrates a screen transmission window applied to a lower cover of a protective case for an out-folding image display device, in which folding and unfolding of the screen display area can be freely performed about a folding axis without interference even when applied to the out-folding image display device.

As shown in FIG. 2, the protective case of an out-folding image display device, in a diary type case or a bumper integrated type case in which folding and unfolding of a screen display area is freely performed without interference even when applied to the out-folding image display device 20 that changes in circumference shape when a flexible display device is folded and unfolded, includes a lower cover 130 selectively covering a folded state storage portion of the flexible display device in a state where one side is fixed or assembled to the diary type case or the bumper integrated type case, and a screen transmission window 131 enabling a user to check the activated screen display information of the folded state storage portion of the flexible display device folded and stored in the inner side of the lower cover without opening and rotating the lower rotation cover 130.

The screen transmission window 131 is formed of a through screen transmission window that is maintained so as to penetratively the lower cover 130, or a sealing screen transmission window that is maintained so as to cover an opened portion with a transparent material after the lower cover 130 is penetratively opened.

1-2. (canceled)

3. A case of an out-folding image display device having a flexible display with a first surface and a second surface which are folded to each other about a folding axis, the case comprising:
an upper cover for covering the first surface of the flexible display;
a lower cover for covering the second surface of the flexible display; and
a connection cover connected to the upper cover and the lower cover and fixed to the out-folding image display device,
wherein the upper cover and the lower cover make or lose contact with the first surface or the second surface of the flexible display based on the connection cover, and the connection cover is fixed to one of both sides of the out-folding image display device except the folding axis thereof.

4. The case of the out-folding image display device of claim 3, wherein the connection cover is located at the opposite end of the folding axis when the out-folding image display device is folded.

5. The case of the out-folding image display device of claim 1, wherein at least one of the upper cover and the lower cover is penetratively opened to expose at least one portion of the first surface and the second surface of the first flexible display device to the outside.

6. The case of the out-folding image display device of claim 3, comprising a transmission window formed in the penetratively opened area.
